(19) United States
(12) Patent Application Publication
(10) Pub. No.: US 2026/0259758 A1
(43) Pub. Date: Sep. 3, 2026

(54) CONCURRENT VIRTUALIZATION OF HARDWARE RESOURCES WITH SECURITY DOMAIN ISOLATION

(71) Applicant: QUALCOMM Incorporated, San Diego, CA (US)

(72) Inventors: Rishabh Jain, Nehtaur Bijnor (IN); Rohit Soneta, Indore (IN); Gaurav Jindal, Hyderabad (IN)

(21) Appl. No.: 19/067,804

(22) Filed: Feb. 28, 2025

(51) Int. Cl. G06F 9/455

(52) U.S. Cl. CPC G06F 9/45558; G06F 2009/45562; G06F 2009/4557; G06F 2009/45587

(57) ABSTRACT

Hardware is virtualized where a hypervisor creates and manages virtual instances of hardware resources to enable concurrent access by multiple virtual machines with different security requirements. The hypervisor allocates virtual resource instances between virtual machines and establishes isolated access paths for each virtual machine to access its allocated resources. Through this virtualization architecture, virtual machines can execute concurrent operations while maintaining security boundaries between secure and non-secure processing domains. The hypervisor manages resource access and enforces security isolation, preventing unauthorized access between virtual machines and their allocated resources. This approach enables concurrent operation of secure and non-secure virtual machines without compromising security requirements or requiring complete resource hand-offs between security domains.

### TECHNICAL FIELD

Aspects of the present disclosure relate generally to hardware virtualization, and more particularly, to concurrent access of hardware resources across secure and non-secure virtual machine environments.

### BACKGROUND

Computing systems rely on virtualization to manage hardware resources. In a virtualized environment, multiple virtual machines can share underlying hardware resources through abstraction layers managed by a hypervisor. In certain applications, particularly those involving sensitive data processing, some virtual machines require enhanced security measures compared to others operating within the same system. For example, in automotive applications, certain camera sensors process sensitive data that requires secure handling, while others handle general tasks with standard security protocols. Traditional virtualization approaches address this by implementing strict hardware resource hand-offs between secure and non-secure virtual machines.

Current virtualization technologies, however, suffer significant limitations when managing concurrent secure and non-secure operations. For instance, when a secure virtual machine requires access to hardware resources, existing systems must typically suspend non-secure operations and transfer complete control of the resources. This hand-off approach creates inefficiencies and potential performance bottlenecks—especially in systems requiring simultaneous secure and non-secure processing capabilities.

The limitations of current approaches are apparent in applications with multiple hardware resources operating under different security requirements. In automotive systems with multiple camera sensors, some sensors may require secure processing for biometric authentication or occupancy detection, while others simultaneously need to perform general operational tasks such as parking assistance. The inability to efficiently handle these concurrent operations with different security requirements is a significant constraint in system design and implementation. Further, existing solutions often rely on non-secure system components to manage security boundaries, which creates potential vulnerabilities in the security architecture. This reliance on non-secure components to control secure resource allocation introduces risks that may compromise the integrity of secure operations.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in an apparatus. The apparatus includes a memory storing processor-readable code and at least one processor coupled to the memory, the processor executing the code to create, through a hypervisor, a first virtual resource instance and a second virtual resource instance from at least one hardware resource, allocate the first virtual resource instance to a first virtual machine and the second virtual resource instance to a second virtual machine, isolate, through the hypervisor, one or more access paths between the first virtual machine and the first virtual resource instance from one or more access paths between the second virtual machine and the second virtual resource instance, and execute concurrent operations between the first virtual machine and the first virtual resource instance and between the second virtual machine and the second virtual resource instance while maintaining isolation between the first virtual machine and the second virtual machine.

In some examples, the hypervisor prevents access by the first virtual machine to the second virtual resource instance and prevents access by the second virtual machine to the first virtual resource instance. In other examples, the first virtual machine comprises a secure virtual machine and the second virtual machine comprises a non-secure virtual machine, where the at least one hardware resource comprises camera hardware. In further examples, the camera hardware comprises at least one of a GPIO interface, an interrupt controller, a memory segment, or a data port.

In additional examples, the secure virtual machine processes secure camera operations and the non-secure virtual machine processes non-secure camera operations, where the secure camera operations comprise at least one of biometric authentication or secure video processing. In some implementations, the first virtual machine comprises a trusted virtual machine and the second virtual machine comprises a general-purpose operating system.

In yet other examples, the hypervisor creates a first memory space for the first virtual resource instance and a second memory space for the second virtual resource instance, and maintains isolation between the first memory space and the second memory space. In certain examples, the first virtual resource instance and the second virtual resource instance comprise virtualized versions of physical hardware interfaces.

Another innovative aspect of the subject matter described in this disclosure can be implemented in a method. The method includes creating, through a hypervisor, a first virtual resource instance and a second virtual resource instance from at least one hardware resource, allocating the first virtual resource instance to a first virtual machine and the second virtual resource instance to a second virtual machine, isolating, through the hypervisor, one or more access paths between the first virtual machine and the first virtual resource instance from one or more access paths between the second virtual machine and the second virtual resource instance, and executing concurrent operations between the first virtual machine and the first virtual resource instance and between the second virtual machine and the second virtual resource instance while maintaining isolation between the first virtual machine and the second virtual machine.

In some implementations of the method, the hypervisor prevents cross-access between virtual machines and their non-allocated virtual resource instances. In other implementations, the method employs secure and non-secure virtual machines operating on camera hardware resources. In additional implementations, the secure virtual machine handles sensitive operations such as biometric authentication while the non-secure virtual machine manages general camera functions.

Another innovative aspect can be implemented in an apparatus that includes a memory storing processor-readable code and at least one processor coupled to the memory, the processor executing the code to assign a first resource partition to one or more first security attributes and a second resource partition to one or more second security attributes, allocate, through a hypervisor, the first resource partition to a first hardware operation and the second resource partition to a second hardware operation, establish, through the hypervisor, security boundaries between the first resource partition and the second resource partition, and execute the first hardware operation and the second hardware operation concurrently according to the security boundaries between the first resource partition and the second resource partition.

The foregoing aspects enable concurrent operation of secure and non-secure virtual machines through hardware resource virtualization without compromising security. The associated virtualization architecture supports deployment across various hardware configurations while isolating security domains.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same fields of view. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example computing device implementing concurrent virtualization with security domain isolation.

FIG. 2 is a block diagram illustrating an example virtualization system architecture according to some embodiments of the disclosure.

FIG. 3 shows a flow chart of an example method for implementing concurrent virtualization enabling secure and non-secure operations through hypervisor-managed resource isolation according to some embodiments of the disclosure.

FIG. 4 is a block diagram illustrating an example processor configuration implementing the concurrent virtualization method of FIG. 3 in a computing device according to some embodiments of the disclosure.

FIG. 5 shows a flow chart of an example method for processing virtualization requests through resource partitioning and security domain isolation according to some embodiments of the disclosure.

FIG. 6 is a block diagram illustrating an example processor configuration implementing the resource partitioning and isolation method of FIG. 5 in a computing device according to some embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Modern computing environments increasingly demand simultaneous operation of secure and non-secure applications within a single hardware platform. Traditional virtualization implementations face significant challenges in maintaining security boundaries while enabling concurrent access to shared hardware resources (such as camera sensors) with varying security requirements. Current solutions address this limitation through complete resource hand-offs between secure and non-secure virtual machines, which creates inefficiencies and introduces security vulnerabilities when non-secure components control security designations.

As such, the present disclosure provides an innovative virtualization architecture that changes how hardware resources are allocated and managed across security domains. Through hypervisor-managed virtualization, physical hardware resources are transformed into isolated virtual instances and each exclusively allocated to specific virtual machines based on their security requirements. An access control mechanism, implemented within the trusted hypervisor layer, enables isolation between secure and non-secure processing domains while enabling concurrent operation.

In automotive applications, described implementations address complex security requirements across multiple camera subsystems. Consider an advanced driver assistance system (ADAS) that simultaneously processes secure occupancy detection data and non-secure parking assistance information. The hypervisor can create separate virtual instances of camera hardware resources, including GPIO interfaces, interrupt controllers, and memory segments, and the like. The virtualized resources can then be allocated between secure virtual machines handling sensitive operations like biometric authentication and non-secure virtual machines managing general camera functions. The hypervisor can maintain control over security boundaries to prevent unauthorized cross-access while allowing both types of operations to proceed without interruption.

The virtualization mechanism also extends beyond simple resource partitioning. Through management of access paths and memory spaces, the mechanism ensures that each virtual machine operates within a completely isolated environment. Hardware interfaces can be virtualized at a granular level, which allows described implementations to maintain security even when multiple virtual machines require access to different aspects of the same physical hardware. The foregoing approach eliminates overhead associated with traditional resource hand-offs and improves security by removing control of security boundaries from non-secure components.

Particular implementations of the subject matter described in this disclosure may be implemented to realize one or more of the following potential advantages or benefits. In some aspects, the present disclosure provides techniques for improving security in virtualized environments while enabling simultaneous operation of secure and non-secure virtual machines without compromising performance or security boundaries. By implementing hardware resource virtualization through a hypervisor-controlled framework, described implementations can avoid security vulnerabilities inherent in traditional approaches, i.e., where non-secure components dictate security boundaries. Here, virtual machines can operate in completely isolated environments, each with dedicated virtual instances of hardware resources. The hypervisor maintains exclusive control over the boundaries to ensure that security policies cannot be compromised by non-secure components or software.

Resource utilization is improved by eliminating complete resource hand-offs. Instead of complete hand-offs, described implementations have the ability to create and manage virtual instances of hardware resources, which allows multiple virtual machines to operate concurrently without requiring state preservation operations or context switches. In automotive applications, this translates to more efficient processing of multiple camera streams, enabling advanced features like simultaneous secure driver monitoring and non-secure parking assistance without security compromises.

Granular virtualization of hardware interfaces provides remarkable implementation flexibility. Systems can be configured to support various combinations of secure and non-secure operations while maintaining consistent security isolation. This adaptability proves particularly valuable in automotive environments where camera configurations and security requirements may vary significantly across different vehicle models or trim levels. Also, the hypervisor-based management approach introduces an additional advantage in terms of scaling. As more hardware resources or virtual machines are added, described implementations maintain its security properties and performance characteristics. The hypervisor's centralized control over resource allocation and security boundaries ensures that system complexity does not compromise security—even as the number of concurrent operations increases.

The virtualization approach described herein leverages existing capabilities of hardware resources to enable concurrent secure and non-secure operations. Modern hardware components, including GPIO interfaces, interrupt controllers, and memory segments, incorporate virtualization support at the hardware level. This implementation exploits these capabilities to create isolated virtual instances that can be independently allocated between virtual machines with different security requirements. A hypervisor manages the creation and allocation of virtual resource instances. Rather than implementing complete resource hand-offs between secure and non-secure virtual machines, the hypervisor establishes persistent virtual instances of hardware resources. Each virtual instance maintains its own state and configuration, which allows the virtual machines to operate independently on their allocated resources. The hypervisor enforces isolation between the virtual instances through hardware-level security mechanisms.

Further, described approaches introduce access control mechanisms managed exclusively by the hypervisor. When, e.g., creating virtual resource instances, the hypervisor establishes isolated memory spaces and access paths specific to each instance. The isolation boundaries persist throughout system operation to prevent unauthorized cross-access between secure and non-secure domains even during concurrent operation. And the resource management system supports partial resource allocation, allowing control over which hardware capabilities are exposed to different virtual machines. Such an allocation enables the system to maintain security boundaries while maximizing resource utilization. Here, the hypervisor maintains awareness of all resource allocations and enforces access controls through hardware-level security mechanisms rather than relying on software-level protections implemented in non-secure components.

Also, aspects of the security designs described herein improve software-based security controls with hypervisor-managed hardware isolation. Rather than a non-secure virtual machine's camera driver controlled security designations for hardware resources, which creating potential vulnerabilities, described approaches can move all security control to the hypervisor layer. Doing so establishes hardware-enforced security boundaries that cannot be compromised by non-secure components.

The foregoing change enables different security improvement, the isolation between secure and non-secure operations is maintained at the hardware level, preventing unauthorized access regardless of software behavior. Second, virtual machines operate only on their allocated virtual resources, eliminating the security risks associated with resource sharing. Third, the concurrent operation capability eliminates the need for security-sensitive resource hand-offs between virtual machines.

Described approaches are thought to be particularly valuable in automotive applications where multiple camera sensors require different security treatments. For example, a system can simultaneously support secure operations like driver authentication through a dedicated virtual instance while maintaining isolated virtual instances for non-secure operations like parking assistance. The hypervisor can ensure isolation between these concurrent operations while maximizing system performance through efficient resource utilization.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device for capturing image frames using one or more image sensors, such as a smartphone, may include a configuration of one, two, three, four, or more camera modules on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames (such as through a bus) in a memory and/or provide the output image frames to processing circuitry (such as an applications processor). The processing circuitry may perform further processing, such as for encoding, storage, transmission, or other manipulation of the output image frames.

As used herein, a camera module may include the image sensor and certain other components coupled to the image sensor used to obtain a representation of a scene in image data comprising an image frame. For example, a camera module may include other components of a camera, including a shutter, buffer, or other readout circuitry for accessing individual pixels of an image sensor. In some embodiments, the camera module may include one or more components including the image sensor included in a single package with an interface configured to couple the camera module to an image signal processor or other processor through a bus.

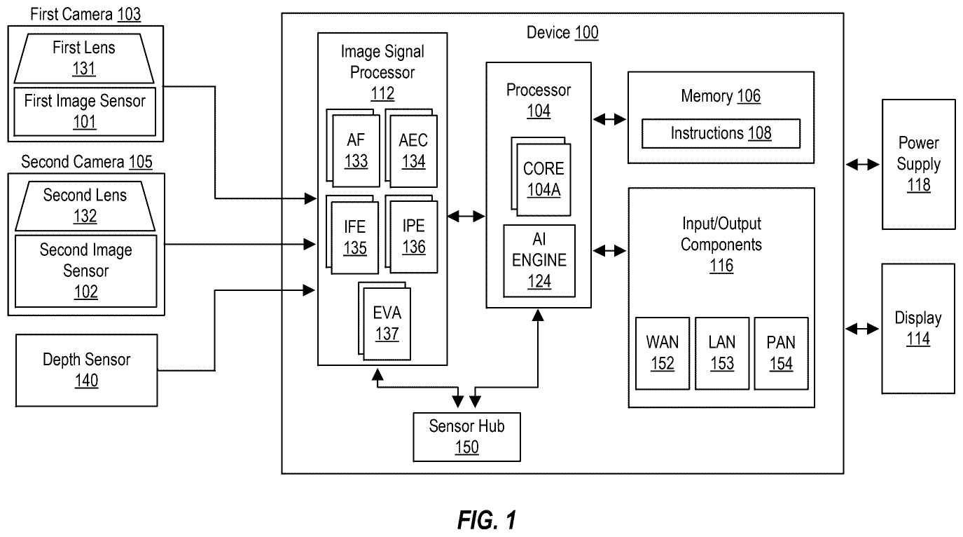

FIG. 1 shows a block diagram of a device 100 for performing image capture from one or more image sensors. The device 100 may include, or otherwise be coupled to, an image signal processor (e.g., ISP 112) for processing image frames from one or more image sensors, such as a first image sensor 101, a second image sensor 102, and a depth sensor 140. In some implementations, the device 100 also includes or is coupled to a processor 104 and a memory 106 storing instructions 108 (e.g., a memory storing processor-readable code or a non-transitory computer-readable medium storing instructions). The device 100 may also include or be coupled to a display 114 and components 116. Components 116 may be used for interacting with a user, such as a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one embodiment, a local bus connection couples the ISP 112 to the first image sensor 101 and second image sensor 102 of a first camera 103 and second camera 105, respectively. In another embodiment, a wire interface couples the ISP 112 to an external image sensor. In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data. The digital image data may be formatted as one or more image frames, whether received from the first camera 103 and/or second camera 105 or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different fields of view (FOVs) to capture different representations of a scene. For example, the first lens 131 may be an ultra-wide (UW) lens and the second lens 132 may be a wide (W) lens. The multiple image sensors may include a combination of UW, W, tele (T), and ultra-tele (UT) sensors.

Each of the first camera 103 and second camera 105 may be configured through hardware configuration and/or software settings to obtain different, but overlapping, FOVs. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A variable aperture (VA) camera may have different characteristics that produced different representations of a scene based on a current aperture size. For example, a VA camera may capture image data with a depth of focus (DOF) corresponding to a current aperture size set for the VA camera.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mmWave, radio detection and ranging (Radar), and/or hybrid depth sensors, such as structured light sensors. In embodiments without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include specific hardware (such as one or more integrated circuits (ICs)) configured to perform one or more operations described in the present disclosure. For example, the ISP 112 may include image front ends (e.g., IFE 135), image post-processing engines (e.g., IPE 136), auto exposure compensation (AEC) engines (e.g., AEC 134), and/or one or more engines for video analytics (e.g., EVA 137). An image pipeline may be formed by a sequence of one or more of the IFE 135, IPE 136, and/or EVA 137. In some embodiments, the image pipeline may be reconfigurable in the ISP 112 by changing connections between the IFE 135, IPE 136, and/or EVA 137. The AF 133, AEC 134, IFE 135, IPE 136, and EVA 137 may each include application-specific circuitry, be embodied as software or firmware executed by the ISP 112, and/or a combination of hardware and software or firmware executing on the ISP 112.

The memory 106 may include a non-transient or non-transitory computer readable medium storing computer-executable instructions as instructions 108 to perform all or a portion of one or more operations described in this disclosure. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or second camera 105 and the ISP 112.

In addition to instructions 108, the memory 106 may also store image frames. The image frames may be output image frames stored by the ISP 112. The output image frames may be accessed by the processor 104 for further operations. In some embodiments, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some embodiments, the device 100 is a system-on-chip (SoC) that incorporates the ISP 112, the processor 104, the sensor hub 150, the memory 106, and/or components 116 into a single package.

In some embodiments, at least one of the ISP 112 or the processor 104 executes instructions to perform various operations described herein, including two-dimensional (2D) tracking across multiple camera views, feature extraction and aggregation, spatial token generation, and three-dimensional (3D) parameter determination. For example, execution of the instructions can instruct the ISP 112 to begin or end capturing image frames or sequences of image frames from multiple surround-view cameras, in which the capture includes feature processing and object tracking as described in embodiments herein. In some embodiments, the processor 104 may include one or more general-purpose processor cores 104A-N capable of executing instructions to control operation of the ISP 112. For example, the cores 104A-N may execute a camera application (or other suitable application for generating images or video) stored in the memory 106 that activate or deactivate the ISP 112 for capturing image frames and/or control the ISP 112 in the application of feature extraction, aggregation, and cross-view object association to the image frames. The operations of the cores 104A-N and ISP 112 may be based on user input. For example, a camera application executing on processor 104 may receive a user command to begin a video preview display upon which video comprising sequences of image frames is captured and processed from multiple surround-view cameras through the ISP 112 for display and/or storage. Image processing to determine object tracking outputs, such as according to techniques described herein, may be applied to one or more image frames in the sequence, including feature normalization, spatial token generation, and 3D parameter determination across multiple views.

In some embodiments, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, face detection and/or object recognition performed using machine learning (ML) or artificial intelligence (AI). The AI engine 124 may be referred to as an Artificial Intelligence Processing Unit (AI PU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training. In some other embodiments, the device 100 does not include the processor 104, such as when all of the described functionality is configured in the ISP 112.

In some embodiments, the display 114 may include one or more suitable displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

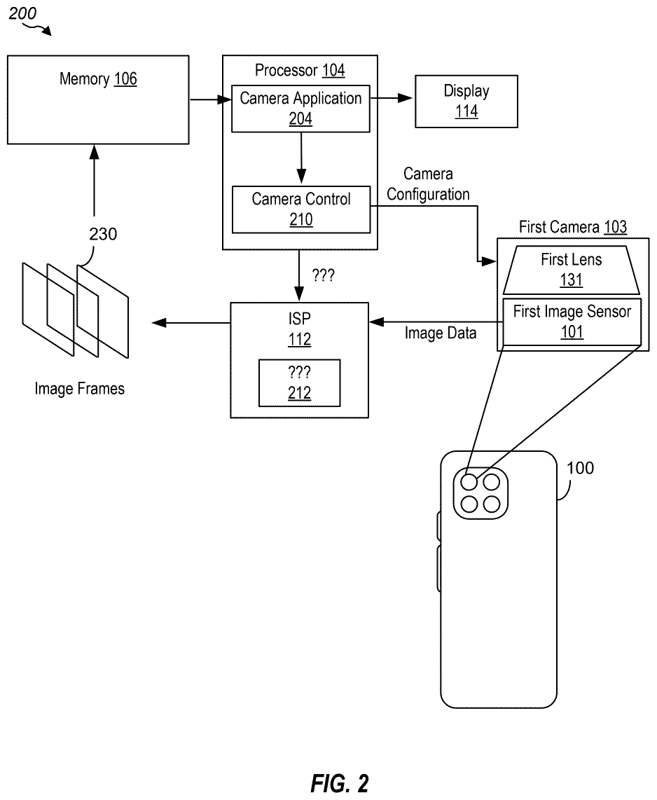

FIG. 2 is a block diagram illustrating an example data flow path for image data processing in an image capture device according to one or more embodiments of the disclosures. Processor 104 of system 200 may communicate with ISP 112 through a bi-directional bus and/or separate control and data lines. The processor 104 may control the first camera 103 through camera control 210. The camera control 210 may be a camera driver executed by the processor 104 for configuring the first camera 103, such as to active or deactivate image capture, configure exposure settings, and/or configure aperture size. Camera control 210 may be managed by a camera application 204 executing on the processor 104. The camera application 204 provides settings accessible to a user such that a user can specify individual camera settings or select a profile with corresponding camera settings. Camera control 210 communicates with the first camera 103 to configure the first camera 103 in accordance with commands received from the camera application 204. The camera application 204 may be, for example, a photography application, a document scanning application, a messaging application, or other application that processes image data acquired from the first camera 103.

The camera configuration may include parameters that specify, for example, a frame rate, an image resolution, a readout duration, an exposure level, an aspect ratio, an aperture size, etc. The first camera 103 may apply the camera configuration and obtain image data representing a scene using the camera configuration. In some embodiments, the camera configuration may be adjusted to obtain different representations of the scene. For example, the processor 104 may execute a camera application 204 to instruct the first camera 103, through camera control 210, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration.

In some embodiments in which the first camera 103 is a variable aperture (VA) camera system, the processor 104 may execute a camera application 204 to instruct the first camera 103 to configure to a first aperture size, obtain first image data from the first camera 103, instruct the first camera 103 to configure to a second aperture size, and obtain second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 corresponds to a larger aperture size than f/8.0.

The image data received from the first camera 103 may be processed in one or more blocks of the ISP 112 to determine output image frames 230 that may be stored in memory 106 and/or otherwise provided to the processor 104. The processor 104 may further process the image data to apply effects to the output image frames 230. Effects may include Bokeh, lighting, color casting, and/or high dynamic range (HDR) merging. In some embodiments, the effects may be applied in the ISP 112.

The output image frames 230 by the ISP 112 may include representations of the scene improved by aspects of this disclosure, such that 3D object parameters are determined directly from 2D tracking data across multiple camera views without requiring birds-eye-view (BEV) feature computation. The processor 104 may display these output image frames 230 to a user, and the improvements provided by the described processing implemented in the ISP 112 and/or processor 104 improve the tracking quality and the user experience by maintaining consistent object tracking across different viewing conditions and camera configurations. For example, feature extraction and aggregation in the ISP 112 may involve processing the image data received from multiple surround-view cameras when determining the output image frames 230, including normalizing extracted features, generating spatial representation tokens, and performing cross-view object association. A tracking consistency maintenance module in the ISP 112 ensures temporal coherence of object tracking across successive frames while handling occlusions and varying object visibility across different camera views.

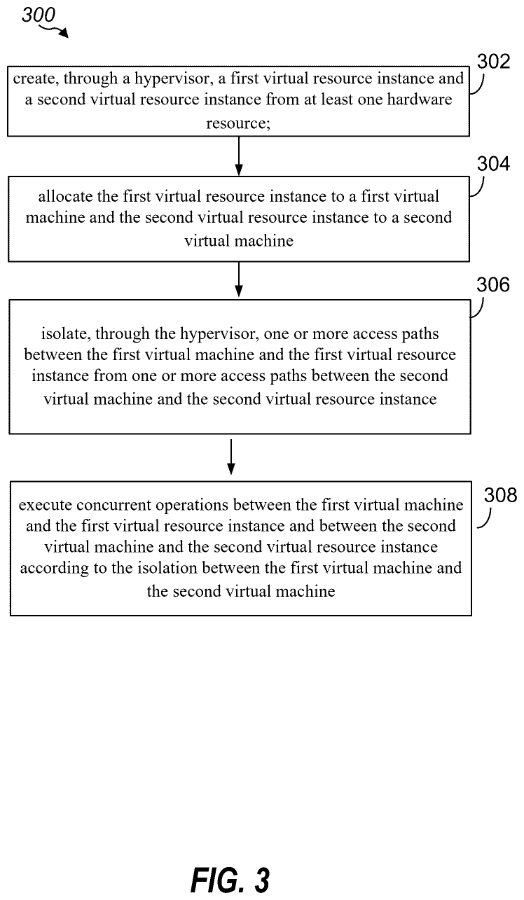

FIG. 3 shows a flow chart of an example method 300 for implementing concurrent virtualization enabling secure and non-secure operations through hypervisor-managed resource isolation according to some embodiments of the disclosure. The processing in FIG. 3 creates isolated virtual instances from hardware resources to enable simultaneous operation of virtual machines with different security requirements. Each of the operations described with reference to FIG. 3 may be performed by one or a combination of the processor 104 (including the hypervisor and virtualization components) or other system components illustrated in FIG. 1. Further, the virtualization system 200 of FIG. 2 may be configured to perform the operations described with reference to FIG. 3.

At block 302, the processor creates, through a hypervisor, a first virtual resource instance and a second virtual resource instance from at least one hardware resource. The virtual instances may be created from camera hardware resources, such as GPIO interfaces, interrupt controllers, memory segments, or data ports. In some implementations, virtual resource creation may be initiated by system software executing on the processor, which coordinates with the hypervisor to establish virtual instances with appropriate security attributes.

At block 304, the processor allocates the first virtual resource instance to a first virtual machine and the second virtual resource instance to a second virtual machine. In some implementations, the first virtual machine comprises a secure virtual machine for processing sensitive operations while the second virtual machine comprises a non-secure virtual machine for general tasks. This allocation enables concurrent operation while maintaining security boundaries between different security domains.

At block 306, the processor isolates, through the hypervisor, one or more access paths between the first virtual machine and the first virtual resource instance from one or more access paths between the second virtual machine and the second virtual resource instance. The hypervisor creates separate memory spaces for the virtual resource instances and maintains isolation between these memory spaces. Through hardware-level security mechanisms, the hypervisor prevents the first virtual machine from accessing the second virtual resource instance and prevents the second virtual machine from accessing the first virtual resource instance.

At block 308, the processor executes concurrent operations between the first virtual machine and the first virtual resource instance and between the second virtual machine and the second virtual resource instance while maintaining isolation between the virtual machines. For camera hardware implementations, the secure virtual machine processes secure camera operations like biometric authentication while the non-secure virtual machine handles general camera functions. The hypervisor continuously enforces security boundaries during concurrent execution through memory isolation and access control mechanisms.

The method 300 supports various implementation scenarios based on different hardware configurations and security requirements. For example, the virtualization architecture adapts to different hardware resource setups while maintaining consistent security isolation across varying operational conditions. In some implementations following the resource allocation at block 304, method 300 can apply different security pathways based on operation sensitivity. The method 300 can route secure operations through protected processing paths while directing non-secure operations through standard virtualization channels to maximize resource utilization while maintaining security boundaries.

After executing concurrent operations at block 308, the method 300 can maintain security boundaries through continuous monitoring and adjustment processes. The hypervisor updates security policies based on new resource requests and preserves isolation as virtual machines access different hardware resources. Specific security validation checks ensure reliable isolation across operational boundaries. For complex virtualization scenarios, the system employs additional security validation techniques after the main processing steps. The method 300 can analyze security relationships within shared resource regions and generates access control data using established security policies. Computing security verification costs between virtual machines across different resource accesses enables the system to maintain consistent isolation during resource transitions or partial hardware access. The method 300 can also adapt virtualization parameters based on specific implementation requirements and hardware configurations. When hardware resources become temporarily unavailable to certain virtual machines, the system adjusts access controls accordingly. This adaptive framework enables concurrent operation across varying hardware setups without requiring complex resource hand-offs or intermediate security validation steps.

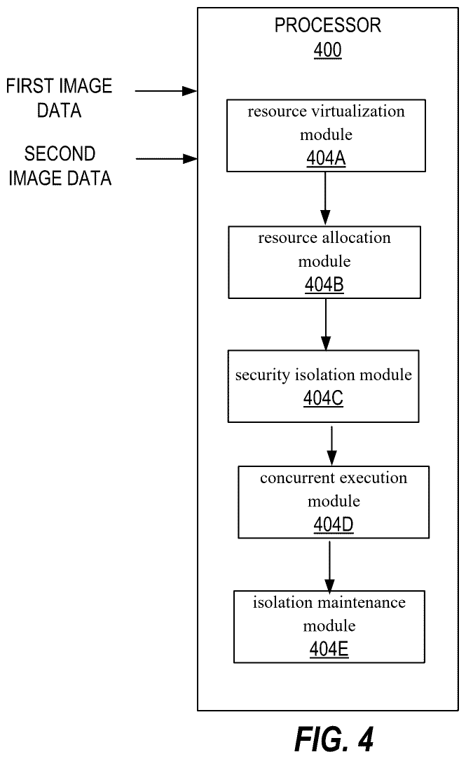

FIG. 4 is a block diagram illustrating an example configuration of processor 400 for implementing concurrent virtualization in a computing device according to some embodiments of the disclosure. The processor 400 may be, operate at, or be part of processor 104 in FIG. 1, or other processing circuitry, and can be configured to execute instructions to perform one or more operations of the method of FIG. 3. Multiple processing cores, e.g., 104A-N can work together to manage parallel virtualization streams across different security domains, while specialized hardware components provide dedicated security enforcement capabilities. The hardware resources undergo various virtualization stages before being allocated between secure and non-secure virtual machines. The processor 400 can be configured to coordinate virtualization operations across multiple hardware resources. This initial stage involves coordination between various system components. Hardware access may be managed directly through dedicated interfaces, or through memory 106 for buffered resource management. In some implementations, specialized security processors can perform preliminary validation before resources enter the main virtualization pipeline. For distributed scenarios, resources may be accessed through network interfaces including the WAN adaptor 152, LAN adaptor 153, or PAN adaptor 154.

Block 404A is a resource virtualization module that can be configured to create virtual instances from hardware resources. The processing block 404A can leverage, in some implementations, multiple hardware accelerators to establish and maintain virtual resource instances. Further, direct memory access (DMA) controllers enable efficient resource allocation between virtual machines while dedicated security hardware maintains isolation even with varying operational demands. The module 404A can include configurable virtualization pipelines that adapt to different hardware characteristics—each with specialized circuits for maintaining security boundaries.

Block 404B is a resource allocation module that can be configured to assign virtual resource instances between virtual machines with different security requirements. Multiple processing elements can operate in parallel to manage resource distribution across security domains. Some implementation maintain security boundaries through dedicated memory management schemes. Also, different allocation paths can execute simultaneously across multiple cores with specialized security engines enforcing access controls. Finally, advanced caching mechanisms can be used to ensure efficient resource access while hardware-assisted security validation maintains consistent isolation.

Block 404C is a security isolation module that can be configured to establish and enforce access path isolation between virtual machines and their allocated resources. The block 404C can implement parallel security enforcement pipelines while preserving isolation boundaries. Described architectures support both secure and non-secure processing paths with dedicated circuits for enforcing security policies. Further, specialized memory controllers can manage isolated memory spaces while hardware synchronization mechanisms ensure coherent security enforcement across different resource accesses.

Block 404D is a concurrent execution module that can be configured to enable simultaneous operation of virtual machines while maintaining security isolation. The block 404D leverages multiple security monitoring units operating in parallel to enforce access controls efficiently. And dedicated memory structures maintain security policies that adapt to different operational requirements, while specialized circuits accelerate security validation. Implementations can include hardware-assisted monitoring mechanisms with power management schemes that activate additional security resources for complex scenarios.

Block 404E is an isolation maintenance module that can be configured to ensure continuous security boundary enforcement during concurrent operation. Multiple hardware elements can work together here—as one or more configured security units accelerate access validation—while dedicated circuits maintain stable isolation across operations. The block 404E can generate security verification data through parallel processing pipelines. Caching schemes and circular buffers enable efficient security monitoring, where hardware circuits continuously assess isolation requirements.

In some implementations, additional hardware modules maintain system-wide security coordination. Examples include dedicated DMA engines for secure data movement, hardware synchronization mechanisms for maintaining security coherence, and specialized circuits for monitoring security policy compliance. Described architectures can incorporate configurable security domains that allow granular isolation management based on operational requirements. Memory management units efficiently handle secure data flow between processing stages while preventing unauthorized access. The processor 400 can operate to support a virtualization pipeline that adapts to varying deployment scenarios while maintaining strict security isolation. Here, hardware-enforced security controls ensure consistent protection across different resource configurations and operational conditions. Further, multiple security validation paths between processing blocks enable dynamic adjustment of isolation parameters.

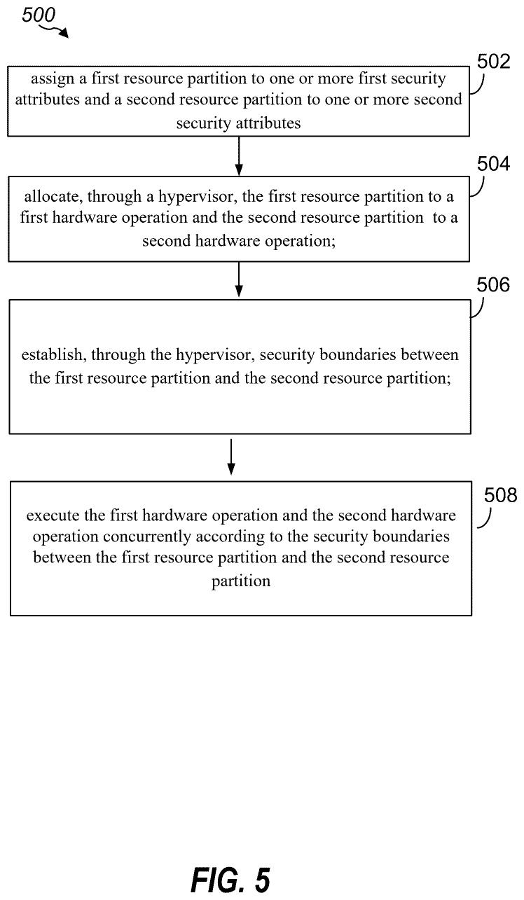

FIG. 5 shows a flow chart of an example method 500 for processing virtualization requests through resource partitioning and security domain isolation according to some embodiments of the disclosure. The processing in FIG. 5 establishes secure and non-secure resource partitions with distinct security attributes to enable isolated concurrent operations. Each of the operations described with reference to FIG. 5 may be performed by one or a combination of the processor 104 and associated security components illustrated in FIG. 1. Further, the virtualization system 200 of FIG. 2 may be configured to perform the operations described with reference to FIG. 5.

At block 502, the processor assigns a first resource partition to one or more first security attributes and a second resource partition to one or more second security attributes. A first resource partition is assigned one or more first security attributes while a second resource partition is assigned one or more second security attributes. The security attributes may define sensitivity levels, access restrictions, and isolation requirements for each partition. In some implementations, attribute assignment may be guided by system security policies that specify protection requirements for different types of operations.

At block 504, the processor allocates, through a hypervisor, the first resource partition to a first hardware operation and the second resource partition to a second hardware operation. The first resource partition is allocated to a first hardware operation while the second resource partition is allocated to a second hardware operation. This allocation maps security-attributed partitions to their corresponding operational domains, enabling isolated concurrent processing while maintaining security boundaries between operations with different sensitivity requirements.

At block 506, the processor establishes, through the hypervisor, security boundaries between the first resource partition and the second resource partition. The hypervisor implements hardware-level isolation mechanisms between the first resource partition and second resource partition. These boundaries prevent unauthorized cross-access between partitions while allowing legitimate operations to proceed within their assigned security domains.

At block 508, the processor executes the first hardware operation and the second hardware operation concurrently according to the security boundaries between the first resource partition and the second resource partition. The first hardware operation and second hardware operation proceed simultaneously while maintaining strict isolation between their respective resource partitions. The hypervisor continuously enforces security boundaries during execution through memory isolation and access control mechanisms.

The method 500 supports various implementation scenarios based on different hardware configurations and security requirements. The virtualization architecture adapts to different resource partition setups while maintaining consistent security isolation across varying operational conditions. In some implementations following partition allocation at block 504, method 500 implements different security pathways based on operation sensitivity. Method 500 routes sensitive operations through protected processing paths while directing standard operations through regular virtualization channels.

After establishing concurrent operations at block 508, method 500 maintains security boundaries through continuous monitoring and adjustment processes. The hypervisor updates security policies based on new operational requirements and preserves isolation as different hardware operations access their allocated partitions. Specific security validation checks ensure reliable isolation across operational boundaries. For complex scenarios, method 500 employs additional security validation techniques after the main processing steps. Method 500 analyzes security relationships within shared resource regions and generates access control data using established security policies. Method 500 adapts virtualization parameters based on specific implementation requirements and hardware configurations. When resource demands change, method 500 adjusts partition allocations while maintaining security boundaries. Such an adaptive framework enables concurrent operation across varying hardware setups without requiring complex security validation steps or compromising isolation between operational domains.

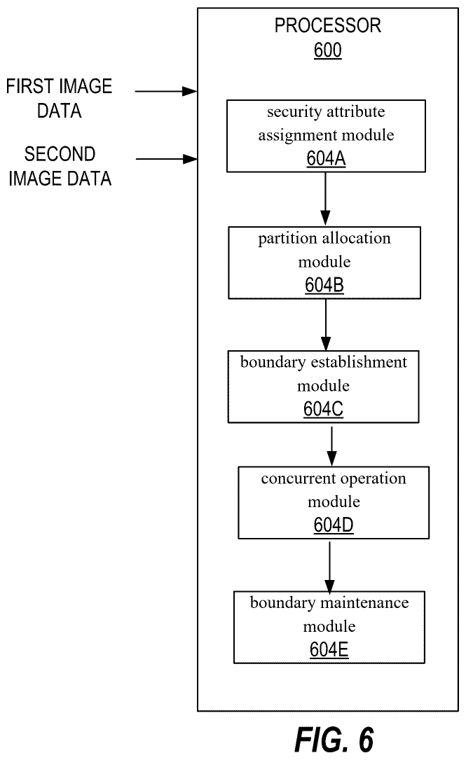

FIG. 6 is a block diagram illustrating an example configuration of processor 600 for implementing resource partitioning and security domain isolation in a computing device according to some embodiments of the disclosure. The processor 600 may be, operate at, or be part of processor 104 in FIG. 1, or other processing circuitry, and can be configured to execute instructions to perform one or more operations of the method of FIG. 5. Multiple processing cores 104A-N can work together to manage parallel security partitions across different operational domains, while specialized hardware components provide dedicated security attribute enforcement. The resource partitions undergo various security classification stages before being allocated to specific hardware operations. The processor 600 can be configured to coordinate security attribute assignment across multiple resource partitions. This initial stage involves coordination between various system components. Partition management may be handled directly through dedicated security interfaces, or through memory 106 for buffered attribute management. In some implementations, specialized security processors can perform preliminary validation before partitions enter the main allocation pipeline. For distributed scenarios, partitions may be accessed through network interfaces including the WAN adaptor 152, LAN adaptor 153, or PAN adaptor 154.

Block 604A is a security attribute assignment module that can be configured to assign security attributes to resource partitions. The processing block 604A can leverage multiple hardware accelerators to establish and maintain security attribute assignments. Direct memory access (DMA) controllers enable efficient attribute management across partitions while dedicated security hardware maintains isolation based on sensitivity levels. The module 604A can also include configurable security classification pipelines that adapt to different operational characteristics—each with circuits for maintaining attribute boundaries.

Block 604B is a partition allocation module that can be configured to assign resource partitions to specific hardware operations based on security requirements. Here, multiple processing elements can operate in parallel to manage partition distribution across operational domains. Some implementations maintain security boundaries through dedicated partition management schemes. Different allocation paths execute simultaneously across multiple cores with specialized security engines enforcing attribute-based controls. Further, advanced caching mechanisms can be used to ensure efficient partition access while hardware-assisted validation maintains consistent security levels.

Block 604C is a boundary establishment module that can be configured to create and enforce security boundaries between resource partitions. The block 604C can implement parallel security enforcement pipelines while preserving isolation based on security attributes. Block 604C can support multiple security classification paths with dedicated circuits for enforcing partition policies. Also, specialized memory controllers manage isolated partition spaces while hardware synchronization mechanisms ensure coherent security enforcement across different operations.

Block 604D is a concurrent operation module that can be configured to enable simultaneous hardware operations while maintaining partition isolation. The block 604D leverages multiple security monitoring units operating in parallel to enforce attribute-based controls efficiently. Dedicated memory structures maintain security policies that adapt to different operational requirements, while specialized circuits accelerate boundary validation. Implementations can include hardware-assisted monitoring mechanisms with power management schemes that activate additional security resources for complex scenarios.

Block 604E is a boundary maintenance module that can be configured to ensure continuous security enforcement during concurrent operations. Multiple hardware elements work together in this critical processing stage—configured security units accelerate attribute validation—while dedicated circuits maintain stable isolation across partitions. The block 604E can generate security verification data through parallel processing pipelines. Caching schemes and circular buffers enable efficient boundary monitoring, where hardware circuits continuously assess isolation requirements.

In some implementations, additional hardware modules can maintain system-wide partition coordination. Examples include dedicated DMA engines for secure partition management, hardware synchronization mechanisms for maintaining attribute coherence, and specialized circuits for monitoring security policy compliance. Described implementations can also incorporate configurable security domains that allow granular partition management based on operational requirements. Further, memory management units efficiently handle secure data flow between processing stages while preventing unauthorized access.

The processor 600 can operate to support a security partitioning pipeline that adapts to varying deployment scenarios while maintaining strict isolation. Here, hardware-enforced security controls ensure consistent protection across different partition configurations and operational conditions. Further, multiple security validation paths between processing blocks enable dynamic adjustment of isolation parameters.

In one or more aspects, techniques for enabling concurrent secure and non-secure virtualization focus on hardware resource management through hypervisor-controlled isolation. One or more aspect relates to an apparatus configured to create and manage virtual instances of hardware resources while maintaining security boundaries between different virtual machines. The apparatus can implement virtualization techniques that allow simultaneous operation of secure and non-secure processes through carefully managed access paths and resource partitioning. The apparatus may operate according to various aspects detailed below—providing novel approaches to hardware virtualization and security domain isolation. In particular, the apparatus employs hypervisor-based control mechanisms to create isolated virtual resource instances to allow concurrent operation of virtual machines with different security requirements without compromising security boundaries. Doing so fundamentally differs from traditional resource hand-off methods by maintaining continuous isolation while enabling simultaneous access to virtualized hardware resources.

Described techniques may be implemented through different architectures. For instance, the apparatus can include at least one processor and associated memory containing instructions for performing the virtualization and security management operations. Other implementations may utilize non-transitory computer-readable media containing executable program code, or may employ specialized hardware components configured specifically for virtualization management. In each case, the implementation maintains hypervisor-controlled resource virtualization and security domain isolation.

In a first aspect, an apparatus includes a memory storing processor-readable code and at least one processor coupled to the memory, the at least one processor configured to execute the processor-readable code to create, through a hypervisor, a first virtual resource instance and a second virtual resource instance from at least one hardware resource, allocate the first virtual resource instance to a first virtual machine and the second virtual resource instance to a second virtual machine, isolate, through the hypervisor, one or more access paths between the first virtual machine and the first virtual resource instance from one or more access paths between the second virtual machine and the second virtual resource instance, and execute concurrent operations between the first virtual machine and the first virtual resource instance and between the second virtual machine and the second virtual resource instance while maintaining isolation between the first virtual machine and the second virtual machine.

In a second aspect, in combination with the first aspect, the hypervisor prevents access by the first virtual machine to the second virtual resource instance and prevents access by the second virtual machine to the first virtual resource instance.

In a third aspect, in combination with one or more of the first aspect or the second aspect, the first virtual machine comprises a secure virtual machine and the second virtual machine comprises a non-secure virtual machine.

In a fourth aspect, in combination with one or more of the first aspect through the third aspect, the at least one hardware resource comprises camera hardware.

In a fifth aspect, in combination with one or more of the first aspect through the fourth aspect, the camera hardware comprises at least one of a GPIO interface, an interrupt controller, a memory segment, or a data port.

In a sixth aspect, in combination with one or more of the first aspect through the fifth aspect, the secure virtual machine processes secure camera operations and the non-secure virtual machine processes non-secure camera operations.

In a seventh aspect, in combination with one or more of the first aspect through the sixth aspect, the secure camera operations comprise at least one of biometric authentication or secure video processing.

In an eighth aspect, in combination with one or more of the first aspect through the seventh aspect, the first virtual machine comprises a trusted virtual machine and the second virtual machine comprises a general-purpose operating system.

In a ninth aspect, in combination with one or more of the first aspect through the eighth aspect, the hypervisor creates a first memory space for the first virtual resource instance and a second memory space for the second virtual resource instance, and maintains isolation between the first memory space and the second memory space.

In a tenth aspect, in combination with one or more of the first aspect through the ninth aspect, the first virtual resource instance and the second virtual resource instance comprise virtualized versions of physical hardware interfaces.

In an eleventh aspect, a method includes creating, through a hypervisor, a first virtual resource instance and a second virtual resource instance from at least one hardware resource, allocating the first virtual resource instance to a first virtual machine and the second virtual resource instance to a second virtual machine, isolating, through the hypervisor, one or more access paths between the first virtual machine and the first virtual resource instance from one or more access paths between the second virtual machine and the second virtual resource instance, and executing concurrent operations between the first virtual machine and the first virtual resource instance and between the second virtual machine and the second virtual resource instance while maintaining isolation between the first virtual machine and the second virtual machine.

In a twelfth aspect, in combination with the eleventh aspect, the hypervisor prevents access by the first virtual machine to the second virtual resource instance and prevents access by the second virtual machine to the first virtual resource instance.

In a thirteenth aspect, in combination with one or more of the eleventh aspect or the twelfth aspect, the first virtual machine comprises a secure virtual machine and the second virtual machine comprises a non-secure virtual machine.

In a fourteenth aspect, in combination with one or more of the eleventh aspect through the thirteenth aspect, the at least one hardware resource comprises camera hardware.

In a fifteenth aspect, in combination with one or more of the eleventh aspect through the fourteenth aspect, the camera hardware comprises at least one of a GPIO interface, an interrupt controller, a memory segment, or a data port.

In a sixteenth aspect, in combination with one or more of the eleventh aspect through the fifteenth aspect, the secure virtual machine processes secure camera operations and the non-secure virtual machine processes non-secure camera operations.

In a seventeenth aspect, in combination with one or more of the eleventh aspect through the sixteenth aspect, the secure camera operations comprise at least one of biometric authentication or secure video processing.

In an eighteenth aspect, in combination with one or more of the eleventh aspect through the seventeenth aspect, the first virtual machine comprises a trusted virtual machine and the second virtual machine comprises a general-purpose operating system.

In a nineteenth aspect, in combination with one or more of the eleventh aspect through the eighteenth aspect, the hypervisor creates a first memory space for the first virtual resource instance and a second memory space for the second virtual resource instance, and maintains isolation between the first memory space and the second memory space.

In a twentieth aspect, an apparatus includes a memory storing processor-readable code and at least one processor coupled to the memory, the at least one processor configured to execute the processor-readable code to assign a first resource partition to one or more first security attributes and a second resource partition to one or more second security attributes, allocate, through a hypervisor, the first resource partition to a first hardware operation and the second resource partition to a second hardware operation, establish, through the hypervisor, security boundaries between the first resource partition and the second resource partition, and execute the first hardware operation and the second hardware operation concurrently according to the security boundaries between the first resource partition and the second resource partition.

In a twenty-first aspect, an apparatus including means for performing operations according to any combination of the first aspect through the twentieth aspect.

In a twenty-second aspect, a non-transitory computer-readable medium including executable instructions that, when executed by at least one processor of an apparatus, cause the apparatus to perform operations according to any combination of the first aspect through the twentieth aspect.

In a twenty-third aspect, a computer program product embodied on a computer-readable storage medium including code for performing operations according to any combination of the first aspect through the twentieth aspect.

In a twenty-fourth aspect, a computing device comprising: at least one transceiver; at least one memory including instructions; and one or more processors, individually or collectively, configured to perform operations according to any combination of the first aspect through the twentieth aspect.

In a twenty-fifth aspect, a virtualization system comprising: at least one memory including instructions; and one or more processors, individually or collectively, configured to perform operations according to any combination of the first aspect through the twentieth aspect.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame,” “modified image frame,” and “corrected image frame” may refer to an image frame that has been processed by any of the disclosed techniques to adjust raw image data received from an image sensor. Further, aspects of the disclosed techniques may be implemented for processing image data received from image sensors of the same or different capabilities and characteristics (such as resolution, shutter speed, or sensor type). Further, aspects of the disclosed techniques may be implemented in devices for processing image data, whether or not the device includes or is coupled to image sensors. For example, the disclosed techniques may include operations performed by processing devices in a cloud computing system that retrieve image data for processing that was previously recorded by a separate device having image sensors.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art will understand that one or more blocks (or operations) described with reference to FIGS. 3 and 4 may be combined with one or more blocks (or operations) described with reference to another of the figures. For example, one or more blocks (or operations) of FIG. 3 may be combined with one or more blocks (or operations) of FIGS. 1-2. As another example, one or more blocks associated with FIG. 4 may be combined with one or more blocks (or operations) associated with FIGS. 1-2.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus, comprising:
a memory storing processor-readable code; and
at least one processor coupled to the memory, the at least one processor configured to execute the processor-readable code, wherein execution of the processor-readable code causes the at least one processor to:
create, through a hypervisor, a first virtual resource instance and a second virtual resource instance from at least one hardware resource;
allocate the first virtual resource instance to a first virtual machine and the second virtual resource instance to a second virtual machine;
isolate, through the hypervisor, one or more access paths between the first virtual machine and the first virtual resource instance from one or more access paths between the second virtual machine and the second virtual resource instance; and
execute concurrent operations between the first virtual machine and the first virtual resource instance and between the second virtual machine and the second virtual resource instance according to the isolation between the first virtual machine and the second virtual machine.

2. The apparatus of claim 1, wherein the hypervisor prevents access by the first virtual machine to the second virtual resource instance and prevents access by the second virtual machine to the first virtual resource instance.

3. The apparatus of claim 1, wherein:
the first virtual machine comprises a secure virtual machine; and
the second virtual machine comprises a non-secure virtual machine.

4. The apparatus of claim 3, wherein the at least one hardware resource comprises camera hardware.

5. The apparatus of claim 4, wherein the camera hardware comprises at least one of a GPIO interface, an interrupt controller, a memory segment, or a data port.

6. The apparatus of claim 4, wherein:
the secure virtual machine processes secure camera operations; and
the non-secure virtual machine processes non-secure camera operations.

7. The apparatus of claim 6, wherein the secure camera operations comprise at least one of biometric authentication or secure video processing.

8. The apparatus of claim 1, wherein:
the first virtual machine comprises a trusted virtual machine; and
the second virtual machine comprises a general-purpose operating system.

9. The apparatus of claim 1, wherein the hypervisor:
creates a first memory space for the first virtual resource instance and a second memory space for the second virtual resource instance; and
maintains isolation between the first memory space and the second memory space.

10. The apparatus of claim 1, wherein the first virtual resource instance and the second virtual resource instance comprise virtualized versions of physical hardware interfaces.

11. A method, comprising:
creating, through a hypervisor, a first virtual resource instance and a second virtual resource instance from at least one hardware resource;
allocating the first virtual resource instance to a first virtual machine and the second virtual resource instance to a second virtual machine;
isolating, through the hypervisor, one or more access paths between the first virtual machine and the first virtual resource instance from one or more access paths between the second virtual machine and the second virtual resource instance; and
executing concurrent operations between the first virtual machine and the first virtual resource instance and between the second virtual machine and the second virtual resource instance while maintaining isolation between the first virtual machine and the second virtual machine.

12. The method of claim 11, wherein the hypervisor prevents access by the first virtual machine to the second virtual resource instance and prevents access by the second virtual machine to the first virtual resource instance.

13. The method of claim 11, wherein:
the first virtual machine comprises a secure virtual machine; and
the second virtual machine comprises a non-secure virtual machine.

14. The method of claim 13, wherein the at least one hardware resource comprises camera hardware.

15. The method of claim 14, wherein the camera hardware comprises at least one of a GPIO interface, an interrupt controller, a memory segment, or a data port.

16. The method of claim 14, wherein:
the secure virtual machine processes secure camera operations; and
the non-secure virtual machine processes non-secure camera operations.

17. The method of claim 16, wherein the secure camera operations comprise at least one of biometric authentication or secure video processing.

18. The method of claim 11, wherein:
the first virtual machine comprises a trusted virtual machine; and
the second virtual machine comprises a general-purpose operating system.

19. The method of claim 11, wherein:
the hypervisor creates a first memory space for the first virtual resource instance and a second memory space for the second virtual resource instance; and
maintains isolation between the first memory space and the second memory space.

20. An apparatus, comprising:
a memory storing processor-readable code; and
at least one processor coupled to the memory, the at least one processor configured to execute the processor-readable code, wherein execution of the processor-readable code causes the at least one processor to:
assign a first resource partition to one or more first security attributes and a second resource partition to one or more second security attributes;
allocate, through a hypervisor, the first resource partition to a first hardware operation and the second resource partition to a second hardware operation;
establish, through the hypervisor, security boundaries between the first resource partition and the second resource partition; and
execute the first hardware operation and the second hardware operation concurrently according to the security boundaries between the first resource partition and the second resource partition.
